(19) United States
(12) Patent Application Publication
(10) Pub. No.: US 2013/0261808 A1
(43) Pub. Date: Oct. 3, 2013

(54) SYSTEM AND METHOD FOR ENERGY MANAGEMENT OF AN HVAC SYSTEM

(71) Applicants: John K. Besore, Prospect, KY (US); Timothy Worthington, Crestwood, KY (US)

(72) Inventors: John K. Besore, Prospect, KY (US); Timothy Worthington, Crestwood, KY (US)

(21) Appl. No.: 13/434,981

(22) Filed: Mar. 30, 2012

(51) Int. Cl. G05D 23/19; G05D 23/24

(52) U.S. Cl. 700/278

(57) ABSTRACT

An energy management system for monitoring airflow from an HVAC system to achieve homogeneous temperature distributions. The system including an HVAC system and an energy module including one or more sensors configured to measure air temperature and at least one of the following: air velocity and relative humidity, a memory, and at least one processor. The at least one processor programmed to access a measured temperature during a period of time, access the HVAC system temperature setpoints, compare the measured temperature of the one or more sensors with the HVAC system temperature setpoints, determine if a difference between the measured temperature and the HVAC system temperature setpoints exceed a high temperature threshold level or a low temperature threshold level, and output a solution to resolve the disparity between the measured stored temperature of the one or more sensors and the HVAC system temperature setpoints.

### BACKGROUND OF THE INVENTION

The field of the invention relates generally to energy management, and more specifically to a system and method for monitoring heating, ventilation, and air conditioning (HVAC) system airflow to identify potential obstacles to and present potential solutions to achieve homogeneous temperature distributions.

In many HVAC systems air temperature regulators (e.g., thermostats) control the thermal environment in response to a set point (e.g., air temperature) inputted by a user. However, thermostatic control of an HVAC system only takes into account only one of the variables that affects thermal comfort, and must rely heavily on the supervisory role of the user. Whenever any of the variables change significantly, the room occupant may experience discomfort, and must determine a new set point air temperature to compensate for the change in the environment. Consequently, an air temperature regulator does not achieve the goal of controlling thermal comfort, since the room occupant may experience uncomfortable conditions under thermostatic control. Furthermore, air temperature regulation control suffers from a translation problem in that some occupants cannot effectively utilize the controls to compensate for changes in the environment. For example, when changing the set point air temperature in an HVAC system controlled by an air temperature regulator, the user ideally must assess his or her own thermal comfort and adjust the air temperature set point such that the correct environmental variable is changed in a manner that results in increased comfort. Furthermore, translating between changing air temperature reference and the effect this change will have on the remaining variables which affect thermal comfort is difficult for most room occupants to contemplate.

Recently, controllers for HVAC systems have been developed that utilize additional information pertaining to thermal comfort. These controllers use a comfort index as the controlled output rather than air temperature. A comfort index is used to predict a room occupant's thermal sensation rating of the environment based on one or more environmental variables such as temperature, humidity, and/or air velocity. A comfort index is used to calculate a predicted thermal sensation rating which corresponds to a particular thermal comfort level. However, while these systems take into account environmental variables such as temperature, humidity, and/or air velocity, these systems do not regulate how to achieve a desired thermal comfort level in an energy efficient manner.

### BRIEF SUMMARY OF THE INVENTION

In one aspect, an energy management system for monitoring airflow from an HVAC system to achieve homogeneous temperature distributions within one or more spaces (such as rooms) is provided. The system includes an energy module including one or more sensors configured to measure air temperature and at least one of the following: air velocity and relative humidity, a memory for storing measurements of the one or more sensors, HVAC system temperature setpoints, and a plurality of solutions to resolve temperature disparities between a temperature of a room and the HVAC system temperature setpoints, and at least one processor. The at least one processor is programmed to access a measured stored temperature of the one or more sensors during a period of time, access the HVAC system temperature setpoints relative to the period of time, compare the measured stored temperature of the one or more sensors with the HVAC system temperature setpoints, determine if a difference between the measured stored temperature of the one or more sensors and the HVAC system temperature setpoints exceed a high temperature threshold level or exceed a low temperature threshold level, and output one or more of the plurality of solutions to resolve temperature disparities between the measured stored temperature of the one or more sensors and the HVAC system temperature setpoints based on an amount that (a) the measured stored temperature of the one or more sensors and (b) the HVAC system temperature setpoints exceed either the high temperature threshold level or exceed the low temperature threshold level.

In another aspect, an energy module for monitoring airflow from an HVAC system to achieve homogeneous temperature distributions is provided. The energy module including one or more sensors configured to measure air temperature and at least one of the following: air velocity and relative humidity. The energy module further including a memory for storing measurements of the one or more sensors, HVAC system temperature setpoints, and a plurality of solutions to resolve temperature disparities between a temperature of a room and the HVAC system temperature setpoints. The energy module further includes at least one processor programmed to access a measured stored temperature of the one or more sensors during a period of time, access the HVAC system temperature setpoints relative to the period of time, compare the measured stored temperature of the one or more sensors with the HVAC system temperature setpoints, determine if a difference between the measured stored temperature of the one or more sensors and the HVAC system temperature setpoints exceed a high temperature threshold level or exceed a low temperature threshold level, and output one or more of the plurality of solutions to resolve the disparity (one example would be to decrease the difference) between the measured stored temperature of the one or more sensors and the HVAC system temperature setpoints based on an amount the measured stored temperature of the one or more sensors and the HVAC system temperature setpoints exceed the high temperature threshold level or exceed the low temperature threshold level.

In yet another aspect, a method for monitoring airflow from an HVAC system to achieve homogeneous temperature distributions is provided. The method comprising: receiving, from a sensor, a temperature of ambient air in a room receiving air from an HVAC system; accessing the HVAC system temperature setpoints, comparing the temperature measured by the sensor with the HVAC system temperature setpoints; determining if a difference between the temperature measured by the sensor and the HVAC system temperature setpoints exceeds a high temperature threshold level or exceeds a low temperature threshold level; and selects and executes a solution to resolve the disparity between the temperature measured by the sensor and the HVAC system temperature setpoints based on an amount the temperature measured by the sensor and the HVAC system temperature setpoints exceed the high temperature threshold level or exceed the low temperature threshold level.

### BRIEF DESCRIPTION OF THE DRAWINGS

The present disclosure is described in detail below with reference to the attached drawing figures.

FIG. 1 is a block diagram of an energy measurement system.

FIG. 2 is a block diagram of an energy module.

FIG. 3 is a process flow diagram for monitoring airflow from an HVAC system to achieve homogeneous temperature distributions.

### DETAILED DESCRIPTION OF THE INVENTION

While embodiments of the disclosure are illustrated and described herein with reference to energy management, and more specifically to a system and method for monitoring heating, ventilation, and air conditioning (HVAC) system airflow to achieve homogeneous temperature distributions, aspects of the disclosure are operable with any system that performs the functionality illustrated and described herein, or its equivalent.

As Home Energy Management (HEM) systems become more popular, the added features that these systems can offer become more desirable and marketable. The present disclosure provides an energy module that is communicatively coupled with an HEM (or any other data gathering device such as an HEM thermostat, PC, and the like). As described in further detail below, the energy module (e.g., a computing device) includes one or more sensors that measure, record, and transmit pertinent data to the HEM that the HEM processes to determine one or more physical parameters that affect balancing of the HVAC system ducting, and thus allow a non-technical person to balance an HVAC system airflow to achieve a more homogeneous temperature distribution within a home or business. In one embodiment, the one or more sensors measure indoor air dry-bulb temperature, indoor relative humidity, outdoor air temperature, outdoor relative humidity, supply air temperature, and return air temperature; and output signals/data to the HEM, which is indicative of one or more of these parameters.

The information generated by the energy module can also be used as input data for enhanced capabilities of the HEM such that thermal leakage of a room can be estimated This thermal heat leakage can be determined by knowing the volume of air delivered to the room over a specific, finite time period coupled with the average supply air temperature during the same time period and the bulk room temperature for the same period. One skilled in the art of thermodynamics will recognize the thermodynamic heat capacity equation, q=mdot*Cp*Delta T which will give an approximation of the heat leakage of the room during the subject time period by approximating that value from the heat energy delivered into the room via the air, during a steady state temperature window of time. In addition, airflow volume can be adjusted to achieve a desired temperature in a room based on empirical data for the given room over a period of time.

As such, the present disclosure enables a user to optimize the balance of room temperature by receiving and acting upon an outputted solution from a controller and/or an energy management module that is/are coupled with the HVAC system and a user interface. This allows the user to make intelligent decisions about savings in energy costs, which was previously not possible without significant knowledge and equipment. For example, if a given room continually resides at temperatures well below the overall designated setpoint (in cooling mode), the user can be alerted to the situation and be directed to throttle or adjust the diffuser to that particular room to reduce the airflow to that room to precipitate a subsequent increase in temperature. This process can be repeated for all rooms (or spaces) to achieve a balanced throughout a structure. Non-limiting examples of a structure may include a house, a building, a marine vessel, an aircraft, a vehicle, and the like. The measuring device can be permanent for each room or be portable to allow this process to be completed room-by-room.

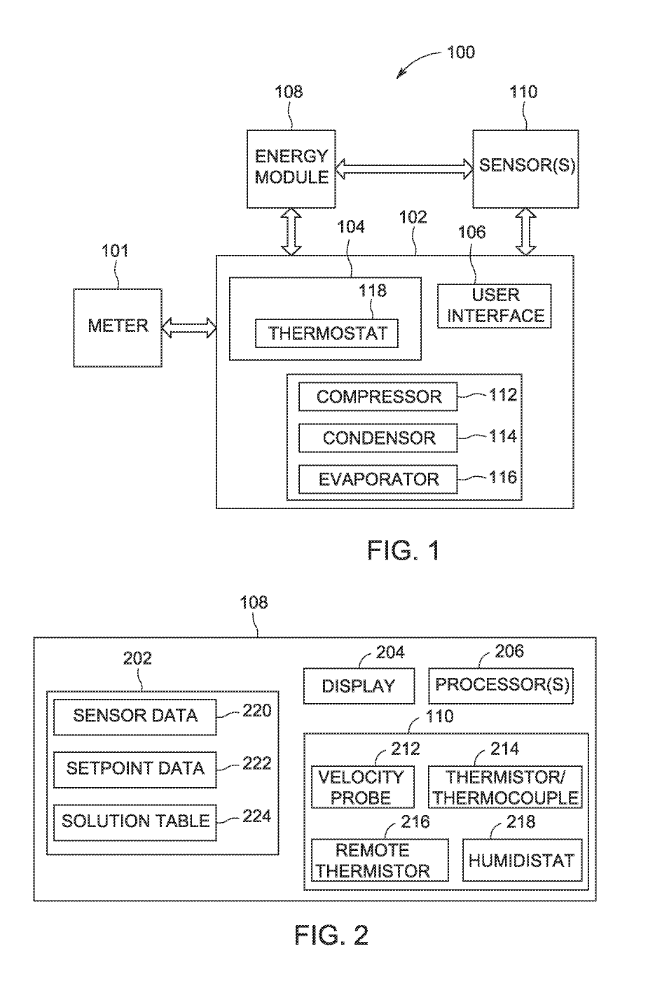

FIG. 1 illustrates a block diagram of an energy measurement system 100 (hereinafter, “system 100”). System 100 includes a HVAC system 102 that includes one or more power consuming features/functions including at least one temperature controlling element for one of heating and cooling air. HVAC system 102 is communicatively coupled to a meter 101 configured to measure electric energy usage, a home area network (HAN) user interface 106, an energy module 108, and one or more sensors 110.

In one embodiment, HVAC system 102 includes a controller 104 operatively connected to each of the power consuming features/functions as well as user interface 106, which may be a capacitive touch screen display configured to be responsive to a user pressing contact on a screen to selectively perform functionality. Thus, a user can operate the desired functions by contacting a surface of the control panel/user interface 106 as well as other functions provided herein.

Controller 104 can operate HVAC system 102 in one of a plurality of operating modes, including, for example, a normal operating mode and an energy savings mode. It should be appreciated that controller 104 can be configured with default settings which govern normal mode and energy savings mode operation or the normal mode and energy savings mode operation may be user defined. Such settings in each mode can be fixed while others adjustable to user preference and to provide response to monitoring airflow.

In one embodiment, HVAC system 102 includes a central air conditioning system, in which at least one temperature controlling element is a refrigeration system that includes a setpoint temperature. The refrigeration system may be a closed loop system defining passages for a refrigerant fluid to flow therein. In one embodiment the refrigeration system includes a compressor 112, a condenser 114, and an evaporator 116. As is well known, compressor 112, which can be driven by electrical energy or other suitable power sources, compresses a low-pressure refrigerant vapor exiting the evaporator 116 into a high pressure and temperature vapor.

In a conventional HVAC system, a thermostat controls the air conditioning system using dry bulb temperature alone. In the exemplary HVAC system 102, a thermostat 118 is one module of controller 104 which controls the operation of system 100. However, in other embodiments within the scope of the present disclosure, thermostat 118 is separate from, but still in communication with controller 104.

As shown in FIG. 1, energy module 108 is operatively/communicatively connected to controller 104, and one or more sensors 110 are operatively/communicatively coupled to energy module 108. Energy module 108 may communicate with user interface 106, controller 104, and one or more sensors 110 via wired and/or wireless networks, for example, local area networks or global networks such as the Internet. In embodiments in which energy module 108 communicates using wireless networks, each of energy module 108, one or more sensors 106, and controller 104 may be enabled with technology such as BLUETOOTH® brand wireless communication services (secured or unsecured), radio frequency identification (RFID), Wi-Fi such as peer-to-peer Wi-Fi, ZIGBEE® brand wireless communication services, near field communication (NFC), and other technologies that enable short-range or long-range wireless communication. In some embodiments, each of energy module 108, one or more sensors 110, and controller 104 may communicate via a wireless cellular network providing Internet access.

With reference now to FIG. 2, a block diagram of the energy module 108 is provided. In one embodiment, the energy module 108 includes a memory 202, a display 204, and at least one processor 206. Display 204 may be, for example, an LED or LCD that displays energy used. In one embodiment, display 204 may perform the functionalities of user interface 106 (as shown in FIG. 1). Thus, user interface 106 may separate from energy module 108 (as shown in FIG. 1) or integrated within energy module 108 as display 204 (as shown in FIG. 2).

Further, while one or more sensors 110 are shown in FIG. 1 to be separate from energy module 108, in one embodiment, as shown in FIG. 2, the one or more sensors 110 may be within energy module 108. In either embodiment, and as shown in FIG. 2, one or more sensors 110 may include one or more of the following: a velocity probe 212 configured to measure air velocity exiting a duct, a humidistat to measure relative humidity of the air exiting the duct, a temperature and humidity sensor to measure bulk air temperature and humidity of the air returning to the HVAC air handler, a temperature and humidity sensor to measure the bulk exiting air properties of the air leaving the A-coil of the HVAC system, a thermistor/thermocouple 214 configured to measure air temperature exiting the duct, a remote thermistor 216 configured to measure stagnant, ambient air temperature in the room receiving air delivered from the duct, and a humidistat 218 configured to measure the bulk relative humidity of the room receiving air delivered from the duct. As explained in further detail below, one or more sensors 110 are configured to record evaporator midpoint temperatures 124 (shown in FIG. 1), condenser midpoint temperatures 122 (shown in FIG. 1), and outdoor ambient temperatures along with run times of compressor 120 (shown in FIG. 1) during operation of HVAC system 102 (shown in FIG. 1) and transmit these measurements to energy module 108 for processing. For example, energy module 108 can utilize the recorded temperatures, humidity measurements, and run times to identify and resolve unbalanced HVAC system airflow as well as provide energy savings recommendations to a user.

In one embodiment, energy module 108 stores data corresponding to the HVAC run times (cycle times) for a given thermostat setpoint temperature and outdoor ambient temperature, which can later be compared to “original” data from when HVAC system 102 was newly installed or functioning properly. Current data is derived for a predetermined finite timeframe (e.g., one or more days) and compared with the “original” data. Energy module 108 can flag fault conditions, such as increased run times for particular ambient temperature and indicate a loss of capacity in HVAC system 102 and/or increased heat leakage of the home or building. Thus, after identifying a loss of capacity, energy module 108 may provide a user with a message indicating that a loss of capacity in HVAC system 102 and/or increased heat leakage of the home or building can be indicative of low charge, a severely clogged air filter, a blocked condenser, failed components, and the like. One of ordinary skill in the art guided by the teachings herein will appreciate that energy module 108 can use evaporator temperatures and condenser temperatures instead of thermostat setpoint temperatures and outdoor ambient temperatures and acquire similar data to diagnose HVAC system 102. Energy module 108 could then alert a user when a component, such as the filter needs changing, or even provide a user with one or more solutions to balance the airflow.

In one embodiment, one or more sensors 110 can be used to characterize the thermal efficiency of the house and/or building. To this end, one or more sensors 110 may be configured to gather and store data regarding the indoor temperature and outdoor temperature coincident with the “rate of change of the indoor temperature versus time” during the off-cycle of HVAC system 102. Energy module 108 can then compare the rate of change (ramp up temperature versus time) for a singular or a series of days with a stored “historical” value established over a specific timeframe and indoor/outdoor coordinate. By this comparison, controller 104 can identify and flag anomalies driven by thermal degradation in windows, insulation, air leaks, doors, and the like and recommend solutions, such as, replacing/fixing the windows, insulation, air leaks, and doors.

Memory 202, or other computer-readable medium or media, stores sensor data 220 (e.g., components and measurements of the one or more sensors 110), setpoint data 222 (e.g., HVAC system temperature setpoints), and a solution table 224 that includes a plurality of possible solutions. In operation, at least one computer processor 206 coupled with the memory 202, accesses and processes one or more of the setpoint data 222 and the solution table 206 to resolve temperature disparities between a temperature of a room and HVAC system 102 temperature setpoints.

This resolution could take the form of guiding the user to adjust the discharge vent air delivery volume to achieve the optimal temperature of a given room relative to the “desired setpoint” established by the user. It may require several “trial & error” iterations to achieve the optimal setpoint that the user desires. If the room is warmer than desired (in a cooling mode) and the diffuser is fully open, no further opportunity exists to balance that particular room without increasing the fan speed (air volume delivery) or adding a booster fan to pull more air into the particular room in question. The system could make such recommendations, and guide the user to a balance point after installation of said equipment or adjustments in fan speed.

While memory 202 is shown to be integrated in energy module 108, memory 202 may be remote from energy module 108, for example, hosted by an Internet cloud service. Such embodiments reduce the computational and storage burden on energy module 108.

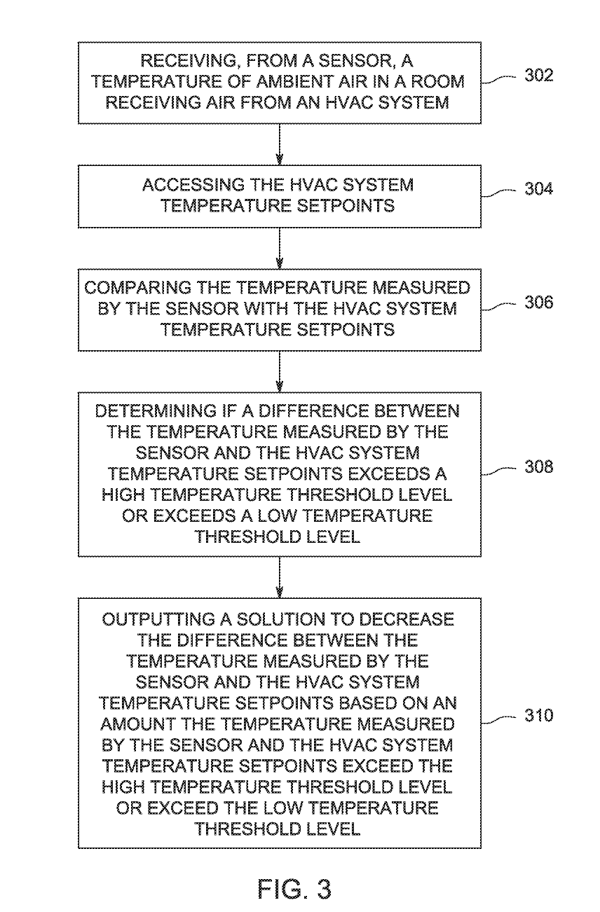

The at least one processor 206 executes computer-executable instructions for implementing one or more features of the methods described herein. In some embodiments, at least one processor 206 is transformed into a special purpose microprocessor by executing computer-executable instructions or by otherwise being programmed. For example, at least one processor 206 is programmed with instructions such as illustrated below with respect to FIG. 3.

FIG. 3 provides an exemplary flow chart that illustrates how monitoring airflow from HVAC system 102 (shown in FIG. 1) can be used to achieve homogeneous temperature distributions throughout one or more spaces (such as rooms). At 302, a temperature of ambient air in a room receiving air from HVAC system 102 is received from one or more sensors 106 (shown in FIGS. 1 and 2). At 304, HVAC system 102 accesses temperature setpoints. In one embodiment, the temperature setpoints are set by a user to define a desired room temperature for a particular period of time (e.g., from 6:00 AM to 5:00 PM, or for a total 24 hour period). At 306, the temperature measured by one or more sensors 106 is compared with HVAC system 102 temperature setpoints. At 308, it is determined (e.g., by controller 104 and/or energy module 108) if a difference between the temperature measured by one or more sensors 108 and HVAC system 102 temperature setpoints exceeds a high temperature threshold level (for example, exceeds the setpoint by about 2° Celsius to about 5° Celsius) or is below a low temperature threshold level (for example, is below the setpoint by about 2° Celsius-about 5° Celsius). At 310, a solution to decrease a difference between the temperature measured by one or more sensors 106 and HVAC system 102 temperature setpoints is output based on an amount the temperature measured by one or more sensors 106 and the HVAC system 102 temperature setpoints exceed the high temperature threshold level or exceed the low temperature threshold level. This solution may be output to a user interface that is coupled with the controller 104 and/or the energy module 108 to notify a user to take action to correct the identified problem. For example, if a temperature of measured ambient air is 25° Celsius and an HVAC system 102 temperature setpoint is 20° Celsius, the difference between the ambient air temperature and HVAC system 102 temperature setpoint is 5° Celsius. As such, if the high temperature threshold level is set at 2° Celsius, the temperature of the ambient air exceeds the high temperature threshold level by 3° Celsius. As such, in one embodiment, energy module 108 accesses a solution in memory 106 that enables a user to maximize a balance of the airflow such that the ambient temperature is below the high temperature threshold or substantially the same as HVAC system 102 temperature setpoint and presents the solution to the user via, for example, display 204. Such a solution may be to check/replace windows, insulation, air leaks, and/or doors, recommending increasing a fan capacity or having air ducts enlarged or adjusting a duct damper or grill damper by a particular percent (e.g., about 25%-about 50%).

Exemplary Operating Environment

A controller or computing device such as is described herein has one or more processors or processing units, system memory, and some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal, such as a carrier wave or other transport mechanism, and include any information delivery media. Combinations of any of the above are also included within the scope of computer readable media.

The controller/computer may operate in a networked environment using logical connections to one or more remote computers, such as a remote computer. Although described in connection with an exemplary computing system environment, embodiments of the present disclosure are operational with numerous other general purpose or special purpose computing system environments or configurations. The computing system environment is not intended to suggest any limitation as to the scope of use or functionality of any aspect of the present disclosure. Moreover, the computing system environment should not be interpreted as having any dependency or requirement relating to any one or combination of components illustrated in the exemplary operating environment. Examples of well-known computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the present disclosure (e.g., such as the method shown in FIG. 3) may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the present disclosure may be implemented with any number and organization of such components or modules. For example, aspects of the present disclosure are not limited to the specific computer-executable instructions or the specific components or modules illustrated in the figures and described herein. Other embodiments of the present disclosure may include different computer-executable instructions or components having more or less functionality than illustrated and described herein. Aspects of the present disclosure may also be practiced in distributed computing environments where tasks are performed by remote processing devices that are linked through a communications network. In a distributed computing environment, program modules may be located in both local and remote computer storage media including memory storage devices.

Aspects of the present disclosure transform a general-purpose computer into a special-purpose computing device when configured to execute the instructions described herein.

The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

Having described aspects of the present disclosure in detail, it will be apparent that modifications and variations are possible without departing from the scope of aspects of the present disclosure as defined in the appended claims. As various changes could be made in the above constructions, products, and methods without departing from the scope of aspects of the present disclosure, it is intended that all matter contained in the above description and shown in the accompanying drawings shall be interpreted as illustrative and not in a limiting sense.

This written description uses examples to disclose the claimed subject matter, including the best mode, and also to enable any person skilled in the art to practice the claimed subject matter, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An energy management system for monitoring airflow from a heating, ventilation, and air conditioning (HVAC) system to achieve homogeneous temperature distributions, the system comprising:
an energy module comprising:
one or more sensors configured to measure air temperature and at least one of the following: air velocity and relative humidity;
a memory for storing measurements of the one or more sensors, HVAC system temperature setpoints, and a plurality of solutions to resolve temperature disparities between a temperature of a room and the HVAC system temperature setpoints; and
at least one processor programmed to:
access a measured stored temperature of the one or more sensors during a period of time;
access the HVAC system temperature setpoints relative to the period of time;
compare the measured stored temperature of the one or more sensors with the HVAC system temperature setpoints;
determine if a difference between the measured stored temperature of the one or more sensors and the HVAC system temperature setpoints exceeds a high temperature threshold level or exceed a low temperature threshold level; and
output one or more of the plurality of solutions to resolve the disparity between the measured stored temperature of the one or more sensors and the HVAC system temperature setpoints based on an amount the measured stored temperature of the one or more sensors and the HVAC system temperature setpoints exceed the high temperature threshold level or exceed the low temperature threshold level.

2. The system of claim 1, further comprising:
a duct configured to deliver air from the HVAC system to a room.

3. The system of claim 2, wherein the one or more sensors comprise a velocity probe configured to measure air velocity exiting the duct.

4. The system of claim 2, wherein the one or more sensors comprise a thermistor or thermocouple configured to measure air temperature exiting the duct.

5. The system of claim 2, wherein the one or more sensors comprise a remote thermistor configured to measure stagnant, ambient air temperature in the room receiving air delivered from the duct.

6. The system of claim 2, wherein the one or more sensors comprise a humidistat configured to measure the relative humidity of the room receiving air delivered from the duct.

7. The system of claim 1, wherein the one or more sensors comprise:
a thermistor or thermocouple configured to measure air temperature exiting the duct; and
a humidistat configured to measure the relative humidity of the room receiving air delivered from the duct; and
wherein the one or more sensors are configured to enable a position of the thermistor or thermocouple and humidistat to be at a fixed distance from the sensor to enable remote placement of the thermistor or thermocouple and humidistat within the room receiving air delivered from the duct.

8. The system of claim 7, wherein the thermistor or thermocouple are configured to adhere to a ceiling surface or wall for gathering surface temperatures for calculating heat leakages of a room.

9. An energy module for monitoring airflow from a heating, ventilation, and air conditioning (HVAC) system to achieve homogeneous temperature distributions, the energy module comprising:
one or more sensors configured to measure air temperature and at least one of the following: air velocity and relative humidity;
a memory for storing measurements of the one or more sensors, HVAC system temperature setpoints, and a plurality of solutions to resolve temperature disparities between a temperature of a room and the HVAC system temperature setpoints; and
at least one processor programmed to:
access a measured stored temperature of the one or more sensors during a period of time;
access the HVAC system temperature setpoints relative to the period of time;
compare the measured stored temperature of the one or more sensors with the HVAC system temperature setpoints;
determine if a difference between the measured stored temperature of the one or more sensors and the HVAC system temperature setpoints exceed a high temperature threshold level or exceed a low temperature threshold level; and
output one or more of the plurality of solutions to resolve the disparity between the measured stored temperature of the one or more sensors and the HVAC system temperature setpoints based on an amount the measured stored temperature of the one or more sensors and the HVAC system temperature setpoints exceed the high temperature threshold level or exceed the low temperature threshold level.

10. The energy module of claim 9, further comprising a duct configured to deliver air from the HVAC system to a room.

11. The energy module of claim 10, wherein the one or more sensors comprise a velocity probe configured to measure air velocity exiting the duct.

12. The energy module of claim 10, wherein the one or more sensors comprise a thermistor or thermocouple configured to measure air temperature exiting the duct.

13. The energy module of claim 10, wherein the one or more sensors comprise a remote thermistor configured to measure stagnant, ambient air temperature in the room receiving air delivered from the duct.

14. The energy module of claim 10, wherein the one or more sensors comprise a humidistat configured to measure the relative humidity of the room receiving air delivered from the duct.

15. The energy module of claim 9, wherein the one or more sensors comprise:
a thermistor or thermocouple configured to measure air temperature exiting the duct; and
a humidistat configured to measure the relative humidity of the room receiving air delivered from the duct; and
wherein the one or more sensors are configured to enable a position of the thermistor or thermocouple and humidistat to be at a fixed distance from the sensor to enable remote placement of the thermistor or thermocouple and humidistat within the room receiving air delivered from the duct.

16. The energy module of claim 15, wherein the thermistor or thermocouple are configured to adhere to a ceiling surface or wall for gathering surface temperatures for calculating heat leakages of a room.

17. A method for monitoring airflow from a heating, ventilation, and air conditioning (HVAC) system to achieve homogeneous temperature distributions, the method comprising:
receiving, from a sensor, a temperature of ambient air in a room receiving air from an HVAC system;
accessing the HVAC system temperature setpoints;
comparing the temperature measured by the sensor with the HVAC system temperature setpoints;
determining if a difference between the temperature measured by the sensor and the HVAC system temperature setpoints exceeds a high temperature threshold level or exceeds a low temperature threshold level; and
outputting a solution to resolve the disparity between the temperature measured by the sensor and the HVAC system temperature setpoints based on an amount the temperature measured by the sensor and the HVAC system temperature setpoints exceed the high temperature threshold level or exceed the low temperature threshold level.

18. The method of claim 17, wherein if a difference between the temperature measured by the sensor and the HVAC system temperature setpoints exceeds a high temperature threshold level, the solution to decrease the difference between the temperature measured by the sensor and the HVAC system temperature setpoints comprises one or more of the following: options to minimize a heating/cooling load in the room; a recommendation to increase HVAC fan capacity; a recommendation to increase a size of the duct; and/or a recommendation to check the duct for blockages.

19. The method of claim 17, wherein if a difference between the temperature measured by the sensor and the HVAC system temperature setpoints exceeds a low temperature threshold level, the solution to decrease the difference between the temperature measured by the sensor and the HVAC system temperature setpoints comprises adjusting the duct by a certain percent based on the difference between the temperature measured by the sensor and the HVAC system temperature setpoints exceeds the low temperature threshold level.

20. The method of claim 17, further comprising:
determining an amount of heated or cooled air escaping from the room; and
outputting a solution to decrease the difference between the temperature measured by the sensor and the HVAC system temperature setpoints based on an amount the temperature measured by the sensor and the HVAC system temperature setpoints exceed the high temperature threshold level or exceed the low temperature threshold level and the determined amount of heated or cooled air escaping from the room.
